(19) United States
(12) Patent Application Publication
(10) Pub. No.: US 2021/0252748 A1
(43) Pub. Date: Aug. 19, 2021

(54) FILM MOLDING TOOL, METHOD FOR PRODUCING A FILM MOLDING TOOL, AND USE OF A FILM MOLDING TOOL

(71) Applicant: Persico SpA, Nembro BG (IT)

(72) Inventors: Rupert Gschwendtner, Bad Reichenhall (DE); -lng. Bernd Stein, Kirchanschöring (DE)

(21) Appl. No.: 16/479,517

(22) PCT Filed: Nov. 13, 2017
(86) PCT No.: PCT/DE2017/000383

§ 371 Date: Aug. 19, 2019

(30) Foreign Application Priority Data
Jan. 20, 2017 (DE) 10 2017 000 487.0
Jul. 28, 2017 (DE) 10 2017 007 115.2

(51) Int. Cl. B29C 33/56; B29C 33/02; B29C 33/42

(52) U.S. Cl. CPC B29C 33/565; B29C 33/42; B29C 33/02

(57) ABSTRACT

The invention relates to a film forming tool for laminating a component with a laminating element or for molding a thermoplastic film with an embossed geometry; an alternative method for embossed shell production and use of a respective film forming tool.

In particular, the invention relates to a manufacturing method for embossed shells which saves both manufacturing time and manufacturing costs and which allows a long service life as well as a high molding quality.

For this purpose, the mold shell of a film forming tool is provided with a ceramic layer which has an embossment structure, allowing a transfer of the embossment structure to the laminating element with the laminating method.

The invention relates to a film forming tool, a method of manufacturing a film forming tool and a use of a film forming tool.

Surfaces in an automobile are often manufactured with a film which is applied on carrier components during a lamination process. It is known that the carrier component is either laminated with an embossed film or alternatively with an even film, wherein in the latter case, embossing takes place during the lamination by means of an embossed upper die.

It is furthermore known that an embossed film or an even film are formed by means of a film forming tool, wherein even films are often embossed during forming. The formed films are subsequently subjected to a back foaming or back injection molding in a separate work step.

If the surface embossment is transferred to the film by means of a molding process, a concave mold shell is used in the molding plant which has a surface texture also called “negative embossment structure”, which causes an embossment of the film during the molding process. The force acting between the film and the mold shell, which is necessary for embossment of the film, can be achieved by suction of the surface by means of a vacuum, by the application of compressed air, by a mechanical application force, or by a combination of these methods.

If surface embossment is achieved during the lamination process, a mold shell with a surface texture is used in the lamination plant, which causes an embossment of the film during the lamination. The force acting between the film and the mold shell, which is necessary for the embossment of the film, can be achieved by suction of the surface by means of a vacuum, by the application of compressed air, by a mechanical application force or by a combination of these methods.

An advantage of embossment during the lamination process or the molding process is that the embossment structure is produced in a three-dimensional state of the film and therefore no loss of the embossment structure can be caused by expansion, as it is the case often with alternative methods. A loss of embossment structure is an impairment of the optical or haptic embossment quality on the supporting part of the film.

A mold shell with a negative embossment structure is frequently also called “embossment shell” and is often produced by electroplating. For this purpose, nickel is deposited on a positive model of the outer contour of the finished component with a positive embossment structure until a layer of approx. 4 mm thickness has formed.

As a variant of a nickel shell with a negative embossment structure, a milled steel shell can be used which has received a negative embossment structure by means of etching. The production of a steel shell is faster than that of a nickel shell produced by electroplating.

As an alternative to producing the surface texture of a steel shell by etching, it can also be produced by means of a laser.

Another variant is a plastic shell with a negative embossment structure which is produced with a second-cast method and which is suitable for the lamination of components or the molding of films in small series.

All known mold shells with negative embossment structures (embossment shells) have in common the property of often being permeable to air so that the necessary force can be produced between the film and the mold shell. The permeability to air can be achieved by perforation, e. g. by means of discrete openings produced by laser or by etching, or by a microporosity of the mold shell which is inherent to the material.

For lamination or molding in a production of large series, an embossment shell is combined with a temperature adjustment system and a substructure, which often has the form of a supporting structure, to form a complete tool structure.

A method of laminating a component by means of a film forming tool is disclosed in DE 10 2013 203 408 A1.

The invention is based on the task of providing the state of the art with an improvement or an alternative.

In a first aspect of the invention, the task is solved by a film forming tool for laminating a component with a laminating element or for forming a film, wherein the film forming tool comprises a mold shell and the mold shell having a metal spray coating produced by metal spraying.

Some terminology will be explained in the following:

First, it is explicitly pointed out that within the framework of the present patent application, indefinite articles and numerals such as “one”, “two” etc. are normally to be understood as indicating a minimum, that is, “at least one . . . ”, “at least two . . . ” etc., unless it becomes explicitly clear from the context or is obvious or technically indispensable to the person skilled in the art that only “exactly one . . . ”, “exactly two . . . ” etc. can be intended.

Furthermore, it is explicitly pointed out that in the framework of the present patent application, a “part” of something is to be understood in the sense that it can also be the entire part of something.

In this context, “film forming” can mean either “lamination” or “molding”.

“Lamination” is understood to be the combination of several layers of identical or different materials. In particular, it is a layer of one film. This film is also called “laminating element”. Generally, the lamination of components is understood to be the lamination of a laminating element with the component to be laminated, wherein the laminating element can be provided with a surface embossment during the lamination.

“Molding” is understood to be the forming of a form element, in particular a film, by means of a film forming tool, wherein the form element can receive a surface embossment during molding. In particular, the molded form element can be employed as a surface in an automobile, with the molded form element, which is in particular a film, being connected to a carrier element in a subsequent process.

A “film forming tool” is preferably understood to be a tool for laminating a component with a laminating element or a tool for molding a form element. Frequently the same film forming tool can be used both for laminating a component with a laminating element and for molding of a form element, the process sequences for lamination and for molding differing from each other.

A film forming tool has at least one mold shell which is normally supplemented by a supporting structure and a temperature adjustment system.

A “film” is understood to be a thin metal, ceramic or plastic sheet.

An “embossment” is understood to be the structuring of a surface, frequently also called “embossment structure”. An embossment is characterized by the haptic and visual characteristics of a surface.

A “mold shell” is understood to be a shell-shaped construction with a specific shape. Mold shells can consist of different materials and combinations of materials. They are used for molding other components and transmit the shape of their surface to the component to be molded. In particular, the landform configuration of a mold shell is inverse to that of the object or model to be formed, for which reason a mold shell is frequently also called “negative mold shell”. The object to be formed or the “model” of this object are frequently also called “positive model”.

A “material layer” is understood to be a layer made of one material, the material layer having a layer thickness within the range of one or more atom layers. A material layer can also have gaps which do not contain the material of the material layer. In other words, a material layer is a coherent layer of atoms of one material.

“Metal spraying” is understood to be a method of spraying metal which is a kind of a surface coating method. In particular, metal spraying includes thermal spraying and cold gas spraying. In metal spraying, metal is molten down or molten on as an additional material inside or outside a gun nozzle, accelerated in a gas flow in the form of spray particles and sprayed onto the surface of the component to be coated. The component surface is generally not molten during this process and only subjected to a small degree of thermal stress.

A “spray coating” is a sprayed material layer with a recognizable thickness. It is built up during thermal spraying, in particular during metal spraying, since the sprayed particles are more or less flattened when they hit the component surface, dependent on the process and on the material, adhere to the surface preferably by mechanical grouting, and building up the spray layer layer by layer. Quality characteristics of spray coatings are low porosity, good adherence to the component, freedom of cracks and a homogeneous microstructure.

The state of the art has provided for the mold shell to be produced by electroplating by means of a film forming tool, with nickel being deposited on a positive model of the finished component, that is, with a positive embossment structure, until a layer with a thickness of approximately 4 mm had been formed. During the electroplating process, mechanical corrections had to be performed in the component from time to time, making this method expensive and time-consuming.

As an alternative, the state of the art has provided for the mold shell of a film forming tool to be milled from a steel block.

Another alternative known in the state of the art has provided for the mold shell of a film forming tool to be made from plastics in a casting method or with a lamination method.

In deviation from this, it is proposed here that the mold shell, a portion of the mold shell or a layer of the mold shell is produced by metal spraying.

Thus, it is conceivable, for instance, that a layer of metal is applied on a positive model by metal spraying and that this metal layer later forms the mold shell, a portion of the mold shell or a layer of the mold shell.

It is also conceivable that an existing part of a mold shell or a layer of a mold shell is complemented and/or reinforced by metal spraying.

It is specifically conceivable, for instance, that the film forming tool is used for laminating carrier components with an embossed or even film.

It is also specifically conceivable, for instance, that the film forming tool is used for forming an embossed or even film. Advantageously, it can be achieved in this manner that a mold shell for a film forming tool, which has a long service life and is suitable for the production of large series, can be produced inexpensively, comparatively quickly and with a high molding quality. Furthermore, the film forming tool can produce positive models with a high molding quality even without requiring a finishing process.

Preferably, the mold shell has two material layers made of different materials.

Thus, it is specifically conceivable, for instance, that the mold shell of a film forming tool can be made of various materials.

For instance, the mold shell can be made of two layers consisting of different materials.

Furthermore, it is conceivable to use different materials in different parts of the mold shell.

In this manner, the characteristics of different materials can be made targeted use of, depending on the specific requirements on different parts of the mold shell, by using different materials in different regions.

Thus, in a specific embodiment, a material with high abrasion resistance could be employed on the surface of the mold shell, a second, lower layer being made of a different material which is suitable to provide the mold shell with the necessary rigidity.

Advantageously, in this manner, the characteristics of different materials can be combined in such a way as to improve the overall properties of the mold shell.

In particular, it can advantageously be achieved in this manner that a mold shell for a film forming tool, which has a long service life and is suitable for the production of large series, can be produced inexpensively, comparatively quickly and with a high molding quality. Furthermore, the film forming tool can produce positive models with a high molding quality even without requiring a finishing process.

Optionally, a surface of the mold shell contains ceramics or consists of ceramics. Ceramics has a high surface hardness and therefore a high degree of abrasion resistance. Thus, it is conceivable to form the surface of the mold shell from a ceramic layer and to apply, for instance, a metal layer of the same or of a higher thickness on this ceramic layer by metal spraying.

The ceramic layer itself can be produced in many different ways.

Advantageously, in this manner, the mold shell can obtain a very high abrasion resistance by means of the ceramic surface and at the same time can obtain the required dimensional stability and stiffness from the metal layer applied by metal spraying.

In particular, it can advantageously be achieved in this manner that a mold shell for a film forming tool, which has a long service life and is suitable for the production of large series, can be produced inexpensively, comparatively quickly and with a high molding quality. Furthermore, the film forming tool can produce positive models with a high molding quality even without requiring a finishing process.

Preferably, the surface of the mold shell has a negative embossment structure.

Some terminology will be explained in the following:

A “negative embossment structure” is the structure of a surface of a component, in particular a mold shell, which is designed as a negative mold shell, with the landform configuration of the mold shell being inverse to that of the object or model to be formed and the model having an embossment structure; i. e. the negative mold shell has a negative embossment structure.

This enables production of a film forming tool which has a mold shell with a negative embossment structure, bearing the embossment information for the component to be laminated or molded, such that embossment of the laminating element can take place during lamination, or embossment of a film can take place during molding.

A mold shell with an outer ceramic layer is conceivable bearing the embossment information and stiffened by a metal layer which has been applied with the spraying method so that the mold shell has the necessary form stability.

It is specifically conceivable, for instance, that the film forming tool is used for laminating carrier components, an originally even film being provided with an embossment structure during lamination so that the surface of the laminated component subsequently bears an embossment structure.

It is also specifically conceivable, for instance, that the film forming tool is used to form an even film, wherein during forming the film also obtains an embossment structure. The film formed and embossed in this manner can subsequently be subjected to back foaming and/or back injection molding, resulting in a component with an embossed surface.

Advantageously, a mold shell with a high abrasion resistance and high dimensional stability can be provided in this manner, by means of which embossment of the laminating element during lamination or of a film during a molding process can be performed.

By embossment during the lamination process or during molding, the embossment structure can furthermore be advantageously produced in the three-dimensional state of the film, preventing a loss of the embossment structure as is frequently the case with alternative methods.

In particular, in this manner, advantageously a mold shell for a film forming tool with a long service life, which is suitable for the production of large series, can be manufactured at low cost, comparatively quickly and at a high molding quality. Furthermore, the positive model of the film forming tool can have a high molding quality, even without requiring a finishing process.

Optionally, the surface of the mold shell is permeable to air.

Some terminology will be explained in the following:

“Permeable to air” is intended to mean that the surface of the mold shell is permeable to air; i. e. air can pass through the mold shell surface.

Thus, it is conceivable, for instance, that the laminating element is sucked into the mold shell through a vacuum applied at the back of the mold shell, so as to produce the force necessary for embossing the laminating element between the laminating element and the mold shell, or to produce the force necessary for embossing the film between the film and the mold shell.

In a particularly well-suited embodiment, the material of the mold shell is permeable to air. Thus, it is conceivable that the spray coating produced by metal spraying has a porosity which makes the mold shell permeable to air so that the laminating element and/or the film can be aspirated into the mold shell by means of a vacuum applied to the back of the mold shell.

Furthermore, in a particularly well-suited embodiment, it is conceivable for a mold shell consisting of several material layers to be permeable to air due to the properties of the material layers; in particular, the mold shell consists of material layers of different materials. Thus, it is specifically conceivable, among others, that a mold shell consisting of a ceramic layer and a metal spray coating has an overall porosity which makes the mold shell permeable to air so that the laminating element and/or the film can be sucked into the mold shell by means of a vacuum applied to the back of the mold shell. In particular, it is conceivable for both the ceramic layer and the metal spray coating to be microporous.

Advantageously, in this manner, the lamination process and/or the molding process can come up to high quality standards as well as being low-cost and quick.

Also, it can advantageously be achieved that embossment of the laminating element can take place during lamination or embossment of the form element can take place during molding, respectively.

If the permeability to air of the mold shell is due to the use of porous materials, in particular, it can advantageously be achieved that the mold shell does not have to be perforated.

Preferably, the mold shell has a supporting structure on its back side.

Some terminology will be explained in the following:

By “supporting structure”, a kind of skeleton is intended which stiffens the mold shell behind the material layer which forms the surface of the mold shell.

Advantageously, in this manner, a very high overall stiffness of the mold shell can be achieved, improving the quality of the laminated components, especially with a view to the reproducibility of components with component geometries which vary only within small tolerances.

In particular, in this manner, advantageously a mold shell for a film forming tool with a long service life, which is suitable for the production of large series, can be manufactured at low cost, comparatively quickly and at a high molding quality. Furthermore, the positive model of the film forming tool can have a high molding quality even without requiring a finishing process.

Optionally, the supporting structure is honeycomb-shaped.

Some terminology will be explained in the following:

“Honeycomb-shaped” is intended to mean a cell-shaped material pattern consisting of individual cavities.

Advantageously, in this manner, a particularly lightweight and stiff supporting structure for the mold shell of a film forming tool can be achieved.

Preferably, the supporting structure has webs.

Some terminology will be explained in the following:

A “web” is part of a framework consisting of webs.

Advantageously, in this manner, a particularly lightweight and stiff supporting structure for the mold shell of a film forming tool can be obtained which additionally allows low-cost production.

Optionally, part of the supporting structure is made of aluminum.

Advantageously, in this manner, the properties of aluminum can be made targeted use of in accordance with the specific requirements of the supporting structure. Specifically, by using aluminum, heat conduction in the supporting structure can be improved or the supporting structure can be made more lightweight.

Preferably, an interspace of the supporting structure contains aluminum gravel.

Some terminology will be explained in the following:

The term “aluminum gravel” designates a grain size of an elementary aluminum granulate. The grain size of aluminum gravel normally ranges from 0.3 mm to 1 mm.

It is explicitly pointed out that “aluminum gravel” also designates a composite material made of the elementary aluminum granulate and a matrix. In particular, the matrix contains natural or synthetic resin. The synthetic resin can be, in particular, epoxy resin or other duroplasts or thermoplasts. Furthermore, the matrix can contain a hardener which hardens the natural or synthetic resin.

Advantageously, in this manner, the interspace of the supporting structure can be condensed with aluminum gravel, improving heat conductivity and stiffness of the film forming tool while maintaining a low weight.

Optionally, the mold shell has aluminum gravel on its back side.

Advantageously, in this manner, the mold shell can be stiffened by means of the aluminum gravel on the back side and obtains a high overall stiffness, improving the quality of the laminated components, especially with a view to the reproducibility of components with component geometries which vary only within small tolerances.

Optionally, the film forming tool has a temperature adjustment unit.

Some terminology will be explained in the following:

A “temperature adjustment unit” is a device by means of which the temperature in a component can be influenced. A temperature adjustment unit can be provided with a temperature controller adapted to maintain the temperature of a component within a predefined range.

Within the framework of this document, “cooling” can also be intended to mean “heating”. In particular, a cooling unit may cool one area and at the same time heat another area.

Advantageously, in this manner, the film forming tool can be set at an optimum temperature of use by means of the temperature adjustment unit.

Preferably, the temperature adjustment unit has a cooling channel. Some terminology will be explained in the following:

A “cooling channel” is a channel through which a fluid can flow, the fluid absorbing or delivering a heat flux from the environment of the cooling channel.

Advantageously, in this manner, the film forming tool can have a liquid cooling system which makes it possible to exploit all advantages of liquid cooling for the film forming tool. Liquid cooling allows a very responsive and efficient cooling of components.

Optionally, the cooling channel comprises copper.

Advantageously, in this manner, the characteristics of copper can be made targeted use of in accordance with the specific requirements of a cooling channel. Copper is a soft and easily moldable material which is particularly well suited to conduct a heat flux.

Thus, a cooling channel made of copper will be an easily moldable and efficient cooling channel with a particularly high reaction speed for the cooling effect.

Preferably, part of the cooling channel extends into the metal spray coating.

Advantageously, in this manner, the cooling power of the cooling channel can directly be made use of in the metal spray coating so as to regulate the temperature of the film forming tool's surface in a very responsive manner.

Optionally, part of the cooling channel extends into the supporting structure.

Advantageously, in this manner, the supporting structure can be cooled in an efficient and responsive manner.

Preferably, part of the cooling channel extends into the aluminum gravel.

Advantageously, in this manner, an area of the film forming tool which consists of aluminum gravel can be cooled in an efficient and responsive manner.

Optionally, the film forming tool has a cooling plate.

Some terminology will be explained in the following:

A “cooling plate” is a component which, in addition to other functionalities, also has specific properties allowing an efficient cooling of surrounding components.

Advantageously, in this manner, the film forming tool can be cooled efficiently. In a cooling plate, heat flows can be particularly well distributed, and temperatures can homogenize.

Preferably, the cooling plate is even.

Advantageously, by having an even surface, the cooling plate is particularly well suited for positively engaging another component.

Optionally, part of the cooling channel extends into the cooling plate.

Advantageously, in this manner, the cooling plate can be cooled by liquid cooling in an efficient and responsive manner.

In a second aspect of the invention, the task is solved by a method of manufacturing a film forming tool, in particular a film forming tool according to the first aspect of the invention, wherein a ceramic layer is applied on a positive model, the ceramics having an embossment, and a metal layer is sprayed onto the ceramic layer.

The state of the art has provided for the surface of the film forming tool which comes into effective contact with the laminating element, during lamination, or with a film, during the molding process, to either be molded in an electroplating process, to be cast with plastics in a casting process or to be worked out of a steel block. Especially in case of mold shells with negative embossment structures, the embossment structure was directly molded, worked with a metal-cutting tool or chemically etched from the material.

In deviation from this, it is proposed here to directly use for the surface of the film forming tool, which comes into effective contact with the laminating element, during lamination, or with a film, during the molding/casting process, a ceramic layer which already has a negative embossment structure. The ceramic layer is stiffened by combining the back side with a metal layer applied during metal spraying to form a mold shell. In the subsequent steps, this mold shell is supplemented with a supporting structure and, if applicable, with a temperature adjustment unit to form a complete film forming tool.

Thus, it is conceivable, for instance, to use a ceramic film for the surface during manufacturing of the film forming tool, the ceramic film already having a negative embossment structure.

The embossment structure of such a ceramic film may have been produced, for example, by means of a previous embossment or a previous casting process from a respective model with an embossment structure.

A conceivable embodiment of an embossed ceramic film suitable for the method described is the Cera-Shibo product of Eschmann Textures International GmbH.

Advantageously, it can be achieved in this manner that a mold shell for a film forming tool, which has a long service life and is suitable for the production of large series, can be produced inexpensively, comparatively quickly and with a high molding quality. Furthermore, the negative embossment structure of the film forming tool can have a high degree of quality even without requiring a finishing process. The negative embossment structure can be very robust.

It is explicitly pointed out that the subject matter of the second aspect can advantageously be combined with the subject matter of the first aspect of the invention.

In a third aspect of the invention, the task is solved by a method of producing a film forming tool, in particular of producing a film forming tool according to the first aspect of the invention, in particular a method according to the second aspect of the invention; wherein a ceramic lacquer is sprayed onto a positive model and hardened, producing a ceramic layer, the positive model having an embossment and a metal layer being sprayed onto the ceramic layer.

Some terminology will be explained in the following:

A “lacquer” is a liquid or powdery coating substance which is thinly applied on objects and built up to form a continuous, hard film by chemical or physical processes. In particular, a lacquer can also be a so called ceramic lacquer.

The state of the art has provided for the surface of the film forming tool which comes into effective contact with the laminating element, during lamination, or with a film, during the molding process, to either be molded in an electroplating process, to be molded with plastics in a casting process or to be produced from a steel block. Especially in case of mold shells with negative embossment structures, the embossment structure was directly molded, worked with a metal-cutting tool or chemically etched from the material.

In deviation from this, it is proposed here to start from a positive model with an embossment structure, apply a ceramic lacquer on the positive model and to stiffen this lacquer with a metal layer applied by metal spraying, resulting in a mold shell. In the subsequent steps, the mold shell is then provided with a supporting structure and, if applicable, with a temperature adjustment unit, so as to form a complete film forming tool.

In this manner, the negative embossment structure is directly transferred by the ceramic lacquer from the embossment structure of the positive model to the mold shell, so that the landform configuration of the mold shell is in particular inverse to the landform configuration of the positive model.

Advantageously, it can be achieved in this manner that a mold shell for a film forming tool, which has a long service life and is suitable for the production of large series, can be produced inexpensively, comparatively quickly and with a high molding quality. Furthermore, the negative embossment structure of the film forming tool can have a high degree of quality even without requiring a finishing process. The negative embossment structure can be very robust.

Preferably, the mold shell consisting of a ceramic layer and a metal layer is perforated.

Some terminology will be explained in the following:

“Perforation” is intended to mean a provision of holes through hollow bodies or flat objects. The arrangement, amount, shape and size of the holes can be homogeneous and/or heterogeneous.

The perforation can be provided with a cutting tool. The spaces between the perforation sites can be selected so as to be homogeneous or heterogeneous.

Advantageously, in this manner, the film forming tool can be made suitable to make a vacuum, applied to the back side of the mold shell through the perforation, act on the laminating element and/or on the film, so that the force necessary for embossing the laminating element and/or the film can be applied between the laminating element and the mold shell or between the film and the mold shell.

Optionally, the mold shell is perforated by laser.

Advantageously, in this manner, the perforation can be performed with very fine pores and thin perforation channels.

Preferably, a cooling channel is embedded in the mold shell.

Advantageously, in this manner, the temperature of the film forming tool can be adjusted to an optimum work temperature. The temperature adjustment unit can use liquid cooling all advantages of which can be exploited for the film forming tool. Liquid cooling allows a very responsive and efficient cooling of components.

In particular, it can advantageously be achieved in this manner that the cooling power issuing from a cooling channel can act directly in the spray coating made of metal allowing a quick and responsive temperature adjustment of the film forming tool surface.

Optionally, the mold shell is connected to a supporting structure.

Advantageously, the mold shell can obtain a very stiff structure in this manner, improving the quality of the laminated components, especially with a view to the reproducibility of components with component geometries which vary only within small tolerances.

In particular, in this manner, advantageously a mold shell for a film forming tool with a long service life, which is suitable for the production of large series, can be manufactured at low cost, comparatively quickly and at a high molding quality. Furthermore, the positive model of the film forming tool can have a high molding quality even without requiring a finishing process.

Preferably, a cooling channel is embedded in the supporting structure.

Advantageously, in this manner, the supporting structure can be cooled in a way that is efficient and responsive.

Optionally, the supporting structure is connected to a cooling plate.

Advantageously, in this manner, the film forming tool can be cooled efficiently. Heat flows can be especially well distributed in a cooling plate, and temperatures can homogenize there.

Preferably, a cooling channel is embedded in the cooling plate.

Advantageously, in this manner, the cooling plate can be cooled in an efficient and responsive manner by liquid cooling.

Optionally, the mold shell can be backfilled with aluminum gravel.

Some terminology will be explained in the following:

“Backfilling” is intended to mean the lining and/or filling of cavities and/or undercuts in the supporting structure of the film forming tool.

Advantageously, in this manner, the interspace of the supporting structure can be condensed with aluminum gravel, which increases the heat conductivity and stiffness of the film forming tool while maintaining a low weight.

Preferably, a cooling channel is embedded in the aluminum gravel.

Advantageously, in this manner, an area of the film forming tool which consists of aluminum gravel can be cooled in an efficient and responsive way.

It is explicitly pointed out that the subject matter of the third aspect can advantageously be combined with the subject matter of the above aspects of the invention, both individually and cumulatively in any combination.

In a fourth aspect of the invention, the task is solved by use of a film forming tool according to the first aspect of the invention for manufacturing and laminating a component, the laminated component having an embossment, or for molding a film from an embossed film forming tool.

It is understood that the advantages of a film forming tool according to the first aspect of the invention, for laminating a component with a laminating element or for molding a film, the film forming tool having a mold shell and the mold shell having a metal spray coating produced by metal spraying, as described above, directly extend to use of a film forming tool according to the first aspect of the invention for manufacturing and laminating a component, the laminated component having an embossment, as well as for molding a film from an embossed film forming tool.

It is explicitly pointed out that the subject matter of the fourth aspect can advantageously be combined with the subject matter of the above aspects of the invention, both individually and cumulatively in any combination.

In the following, the invention will be explained in more detail by means of two examples of embodiment for manufacturing a mold shell, as well as four examples of embodiment for extending a mold shell to form a complete film forming tool, with reference to the drawing wherein

FIG. 1 schematically shows a first variant for manufacturing a mold shell,

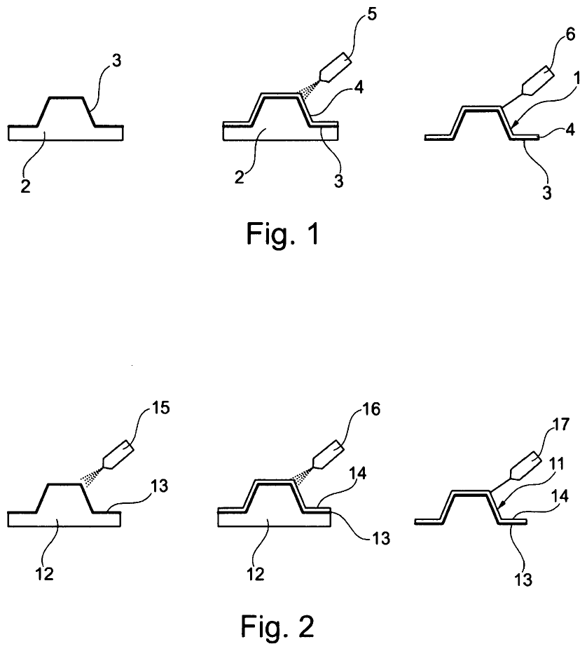

FIG. 2 schematically shows a second variant for manufacturing a mold shell,

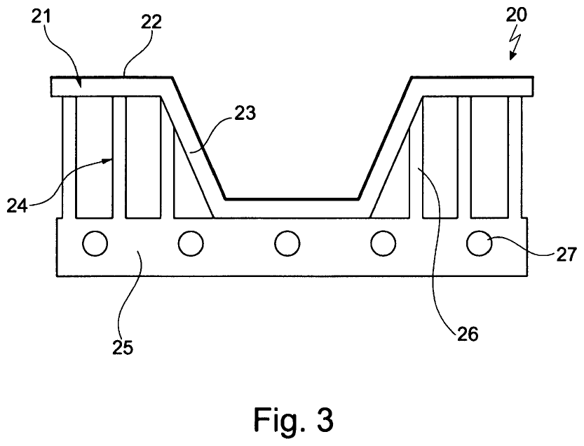

FIG. 3 schematically shows a first variant for constructing a film forming tool,

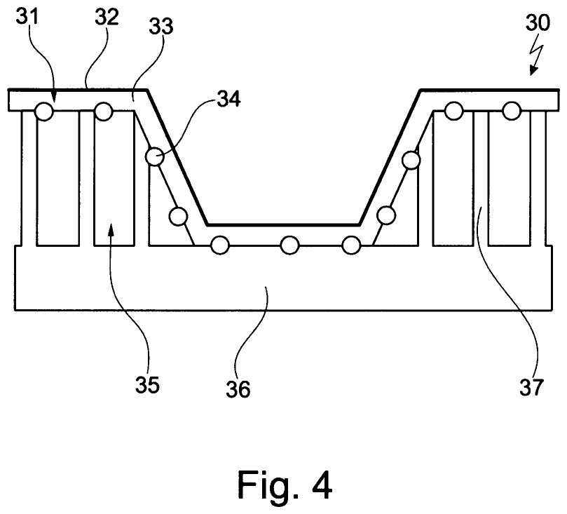

FIG. 4 schematically shows a second variant for constructing a film forming tool,

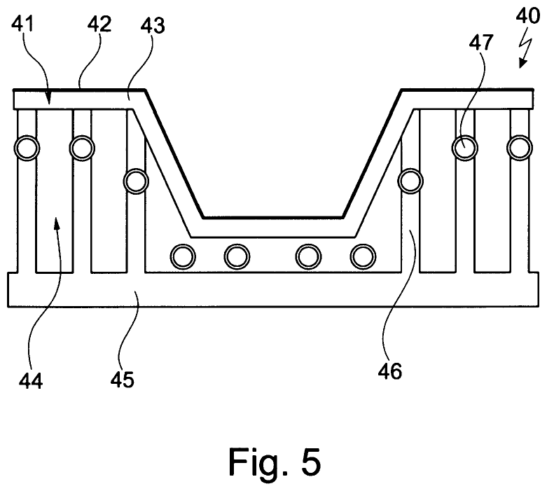

FIG. 5 schematically shows a third variant for constructing a film forming tool and

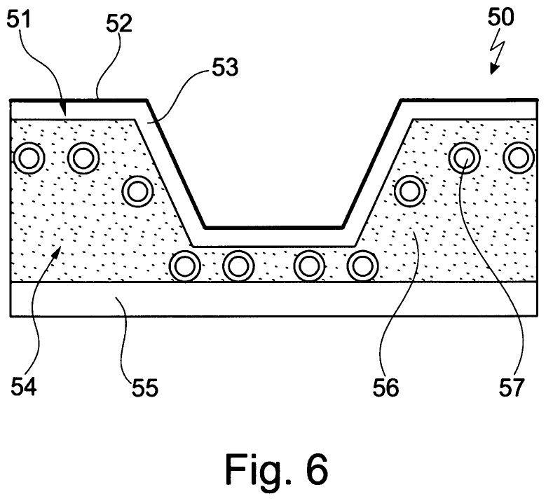

FIG. 6 schematically shows a fourth variant for constructing a film forming tool.

The first type of manufacturing method for a mold shell 1, shown in FIG. 1, substantially consists of three method steps. (These steps are schematically shown in the individual images of FIG. 1, from left to right.) The mold shell 1 substantially consists of a ceramic film 3 and a metal spray coating 4.

In the first method step (left image) of the first manufacturing method of the mold shell 1, shown in FIG. 1, the ceramic film 3 is applied on the milled positive model 2.

The positive model 2 has no embossment (not shown). The ceramic film 3 has an embossment (not shown) which is applied in the direction of the positive model 2.

In the second method step (central image) of the first manufacturing method of the mold shell 1 in FIG. 1, the metal spray coating 4 is applied on the back side of the applied ceramic film 3 by means of a metal spray unit 5. The metal spray coating 4 stiffens the mold shell 1 which consists of the ceramic film 3 and the metal spray coating 4.

After the metal spray coating 4 has been completely applied and hardened, the positive model 2 is separated from the mold shell 1 (not shown).

In the third method step (right image) of the first manufacturing method of the mold shell 1, shown in FIG. 1, the mold shell 1 is perforated by means of a laser 6.

The second type of manufacturing method for a mold shell 11, shown in FIG. 2, substantially consists of three method steps which are schematically shown in the images in FIG. 1 from left to right). The mold shell 11 substantially consists of a ceramic lacquer 13 and a metal spray coating 14.

In the first method step (left image) of the second manufacturing method of the mold shell 11, shown in FIG. 2, the ceramic lacquer 13 is applied on the milled positive model 12 by means of a lacquering unit 15.

The positive model 12 has an embossment (not shown).

In the second method step (central image) of the second manufacturing method of the mold shell 11, shown in FIG. 2, the metal spray coating 14 is applied on the back side of the applied ceramic lacquer 13 by means of a metal spray unit 16. The metal spray coating 14 stiffens the mold shell 11 consisting of ceramic lacquer 13 and metal spray coating 14.

After the metal spray coating 14 has been completely applied and hardened, the positive model 12 is separated from the mold shell 11 (not shown).

In the third method step (right image) of the second manufacturing method of the mold shell 11, shown in FIG. 2, the mold shell 11 is perforated by means of a laser 17.

The first type of film forming tool 20, shown in FIG. 3, substantially consists of a mold shell 21 and a supporting structure 24.

The mold shell 21 substantially consists of a ceramic layer 22 (ceramic film or ceramic lacquer) and a metal spray coating 23.

The supporting structure 24 substantially consists of a cooling plate 25 and webs 26. The supporting structure 24 stiffens the mold shell 21 to form the film forming tool 20.

The film forming tool 20 has cooling channels 27 in the cooling plate 25 by means of which the temperature of the film forming tool 20 can be adjusted.

The second type of film forming tool 30, shown in FIG. 4, substantially consists of a mold shell 31 and a supporting structure 35.

The mold shell 31 substantially consists of a ceramic layer 32 (ceramic film or ceramic lacquer) and a metal spray coating 33.

The supporting structure 35 substantially consists of a cooling plate 36 and webs 37. The supporting structure 35 stiffens the mold shell 31 to form the film forming tool 30.

The film forming tool 30 has cooling channels 34 in the metal spray coating 33 by means of which the temperature of the film forming tool 30 can be adjusted.

The third type of film forming tool 40, shown in FIG. 5, substantially consists of a mold shell 41 and a supporting structure 44.

The mold shell 41 substantially consists of a ceramic layer 42 (ceramic film or ceramic lacquer) and a metal spray coating 43.

The supporting structure 44 substantially consists of a cooling plate 45 and webs 46. The supporting structure 44 stiffens the mold shell 41 to form the film forming tool 40.

The film forming tool 40 has cooling channels 47 in the webs 46 of the supporting structure 44 by means of which the temperature of the film forming tool 40 can be adjusted.

The fourth type of film forming tool 50, shown in FIG. 6, substantially consists of a mold shell 51 and a supporting structure 54.

The mold shell 51 substantially consists of a ceramic layer 52 (ceramic film or ceramic lacquer) and a metal spray coating 53.

The supporting structure 54 substantially consists of a cooling plate 55 and aluminum gravel 56. The aluminum gravel 56 backfills the mold shell 51 and fills the space between the mold shell 51 and the cooling plate 55, complementing and stiffening the mold shell 51 to form the film forming tool 50.

The film forming tool 50 has cooling channels 57 which extend through the aluminum gravel 56 and by means of which the temperature of the film forming tool 50 can be adjusted.

### LIST OF REFERENCE NUMBERS

1 mold shell

2 positive model

3 ceramic film

4 metal spray coating

5 metal spraying unit

6 laser

11 mold shell

12 positive model

13 ceramic lacquer

14 metal spray coating

15 lacquering unit

16 metal spraying unit

17 laser

20 film forming tool

21 mold shell

22 ceramic layer

23 metal spray coating

24 supporting structure

25 cooling plate

26 web

27 cooling channel

30 film forming tool

31 mold shell

32 ceramic layer

33 metal spray coating

34 cooling channel

35 supporting structure

36 cooling plate

37 web

40 film forming tool

41 mold shell

42 ceramic layer

43 metal spray coating

44 supporting structure

45 cooling plate

46 web

47 cooling channel

50 film forming tool

51 mold shell

52 ceramic layer

53 metal spray coating

54 supporting structure

55 cooling plate

56 aluminum gravel

57 cooling channel

1. Film forming tool for laminating a component with a laminating element or for molding a film, wherein the film forming tool has a mold shell,
characterized in that
the mold shell has a metal spray coating produced by metal spraying.

2. Film forming tool according to claim 1, characterized in that the mold shell has two material layers made of different materials.

3. Film forming tool according to claim 1, characterized in that a surface of the mold shell contains ceramics or consists of ceramics.

4. Film forming tool according to claim 1, characterized in that the surface of the mold shell has a negative embossment structure.

5. Film forming tool according to claim 1, characterized in that the surface of the mold shell is permeable to air.

6. Film forming tool according to claim 1, characterized in that the mold shell has a supporting structure on its back side.

7. Film forming tool according to claim 6, characterized in that the supporting structure is honeycomb-shaped.

8. Film forming tool according to claim 6, characterized in that the supporting structure has webs.

9. Film forming tool according to claim 6, characterized in that part of the supporting structure is made of aluminum.

10. Film forming tool according to claim 6, characterized in that an interspace of the supporting structure contains aluminum gravel.

11. Film forming tool according to claim 1, characterized in that the mold shell contains aluminum gravel on its back side.

12. Film forming tool according to claim 1, characterized in that the film forming tool has a temperature adjustment unit.

13. Film forming tool according to claim 1, characterized in that the temperature adjustment unit has a cooling channel.

14. Film forming tool according to claim 13, characterized in that the cooling channel contains copper.

15. Film forming tool according to claim 13, characterized in that part of the cooling channel extends into the metal spray coating.

16. Film forming tool according to claim 13, characterized in that part of the cooling channel extends into the supporting structure.

17. Film forming tool according to claim 13, characterized in that part of the cooling channel extends into the aluminum gravel.

18. Film forming tool according to claim 1, characterized in that the film forming tool has a cooling plate.

19. Film forming tool according to claim 18, characterized in that the cooling plate is even.

20. Film forming tool according to claim 18, characterized in that part of the cooling channel extends into the cooling plate.

21. Method of manufacturing a film forming tool, according to claim 1,
characterized in that
a ceramic layer is applied onto a positive model, the ceramics having an embossment, and a metal layer is sprayed onto the ceramic layer.

22. Method of manufacturing a film forming tool, according to claim 1,
characterized in that
a ceramic lacquer is sprayed onto a positive model and hardened, resulting in a ceramic layer, the positive model having an embossment,
and a metal layer is sprayed onto the ceramic layer.

23. Method of manufacturing a film forming tool according to claim 21, characterized in that the mold shell, consisting of a ceramic layer and a metal layer, is perforated.

24. Method of manufacturing a film forming tool according to claim 21, characterized in that the mold shell is perforated by means of a laser.

25. Method of manufacturing a film forming tool according to claim 21, characterized in that a cooling channel is embedded in the mold shell.

26. Method of manufacturing a film forming tool according to claim 21, characterized in that the mold shell is connected to a supporting structure.

27. Method of manufacturing a film forming tool according to claim 21, characterized in that a cooling channel is embedded in the supporting structure.

28. Method of manufacturing a film forming tool according to claim 21, characterized in that the supporting structure is connected to a cooling plate.

29. Method of manufacturing a film forming tool according to claim 21, characterized in that a cooling channel is embedded in the cooling plate.

30. Method of manufacturing a film forming tool according to claim 21, characterized in that the mold shell is back-filled with aluminum gravel.

31. Method of manufacturing a film forming tool according to claim 21, characterized in that a cooling channel is embedded in the aluminum gravel.

32. Use of a film forming tool according to one of claims 1 through 20 claim 1 for manufacturing and laminating a component, the laminated component having an embossment, or for molding a film from an embossed film forming tool.
